(19) United States
(12) Patent Application Publication
(10) Pub. No.: US 2026/0088913 A1
(43) Pub. Date: Mar. 26, 2026

(54) PHOTON ARCHITECTURE FOR BI-DIRECTIONAL AND CO-DIRECTIONAL LINKS

(71) Applicant: Nvidia Corporation, Santa Clara, CA (US)

(72) Inventors: Liron GANTZ, Haifa (IL); Ashkan SEYEDI, Los Gatos, CA (US); Alon GABBAY, Haifa (IL); Ola OLUWOLE, Los Altos, CA (US); Vishnu BALAN, Austin, TX (US)

(21) Appl. No.: 18/895,876

(22) Filed: Sep. 25, 2024

(51) Int. Cl. H04B 10/80; H04B 10/67; H04J 14/02

(52) U.S. Cl. CPC H04B 10/802; H04B 10/675; H04J 14/03

(57) ABSTRACT

A photonic circuit and/or chip is provided that is configured for selective use in a bi-directional link or a co-directional link. The photonic circuit and/or chip includes a coupling waveguide; receiver filters that are each a tunable bandpass filter; and two or more wavelength branches. Each wavelength branch corresponds to a respective wavelength and includes a receiver arm comprising a signal detection component and a transmitter arm comprising a signal generator configured to provide a transmission signal to the coupling waveguide. The receiver arm is in optical communication with the coupling waveguide via a receiver filter. When the receiver filter is tuned to pass the respective wavelength, the wavelength branch corresponding to the respective wavelength is configured to act as a receiver. When the receiver filter is tuned to not pass the respective wavelength, the wavelength branch corresponding to the respective wavelength is configured to not act as a receiver.

### BACKGROUND

Example embodiments generally relate to the field of photonic circuits and/or chips for use in receiving and/or transmitting signals in an optical network and corresponding methods. For example, various embodiments provide photonic circuits and/or chips that may be operated in a selected one of a bi-directional mode or a co-directional mode.

Optical networks are configured to communicate information via optical signals. For example, optical networks include components configured to generate and provide optical signals and components configured to receive optical signals. As data communication needs continue to increase, optical networks with higher bandwidths are desired. In order to accomplish such higher bandwidth systems, various optical network architectures are being developed and explored. Therefore, a need exists in the art for improved devices for that are capable of operating in accordance with such optical network architectures.

### BRIEF SUMMARY

Some example embodiments provide photonic circuits and/or chips that are operable in a selected one of a bi-directional mode and operable in a co-directional mode. Some example embodiments provide optical networks and/or links that are operable in a selected one of a bi-directional mode and a co-directional mode. Some example embodiments provide methods for use of such optical networks and/or links.

According to an example aspect of the present disclosure, a photonic circuit and/or chip is provided. The photonic circuit and/or chip is configured for selective use as a bi-directional link or a co-directional link. In an example embodiment, the photonic circuit and/or chip comprises at least one coupling waveguide; two or more receiver filters, the two or more receiver filters each being a tunable bandpass filter; and two or more wavelength branches. Each wavelength branch of the two or more wavelength branches correspond to a respective wavelength. Each wavelength branch of the two or more wavelength branches includes a receiver arm comprising a signal detection component and a transmitter arm comprising a signal generator configured to provide a transmission signal to the at least one coupling waveguide. The receiver arm is in optical communication with the at least one coupling waveguide via a receiver filter of the two or more receiver filters. When the receiver filter is tuned to pass the respective wavelength, the wavelength branch corresponding to the respective wavelength is configured to act as a receiver. When the receiver filter is tuned to not pass the respective wavelength, the wavelength branch corresponding to the respective wavelength is configured to not act as a receiver.

According to another aspect of the present disclosure, a photonic circuit and/or chip is provided. In an example embodiment, the photonic circuit and/or chip is configured for selective use as a bi-directional link or a co-directional link. In an example embodiment, the photonic circuit and/or chip includes a first coupling waveguide and a second coupling waveguide, a first receiver arm comprising a first signal detection component configured to detect optical signals of a first wavelength, a second receiver arm comprising a second signal detection component configured to detect optical signals of a second wavelength, a first transmitter arm comprising a first signal generator configured to generate optical signals of the first wavelength, and a second transmitter arm comprising a second signal generator configured to generate optical signals of the second wavelength. The first receiver arm is in optical communication with the first coupling waveguide and the second coupling waveguide via a first pair of receiver filters and the first receiver arm corresponds to the first wavelength. The second receiver arm is in optical communication with the first coupling waveguide and the second coupling waveguide via a second pair of receiver filters and the second receiver arm corresponds to the second wavelength. The first transmitter arm is in optical communication with at least one of the first coupling waveguide or the second coupling waveguide and the second transmitter arm is in optical communication with at least one of the first coupling waveguide or the second coupling waveguide. The first wavelength is different from the second wavelength. Optical filters of the first pair of receiver filters and the second pair of receiver filters are respective bandpass filters. When at least one receiver filter of the first pair of receiver filters is tuned to pass the first wavelength, the photonic circuit is configured to receive optical signals of the first wavelength. When the first pair of receiver filters is tuned to not pass the first wavelength, the photonic circuit is configured to transmit optical signals of the first wavelength. When at least one receiver filter of the second pair of receiver filters is tuned to pass the second wavelength, the photonic circuit is configured to receive optical signals of the second wavelength. When the second pair of receiver filters is tuned to not pass the second wavelength, the photonic circuit is configured to transmit optical signals of the second wavelength.

According to another example aspect of the present disclosure, a method is provided. In an example embodiment, the method comprises at least one of receiving or transmitting respective signals of two or more wavelengths via a photonic circuit and/or chip. The photonic circuit and/or chip includes two or more wavelength branches. Each wavelength branch of the two or more wavelength branches corresponds to a respective wavelength of the two or more wavelengths. Each wavelength branch of the two or more wavelength branches includes a receiver arm comprising a signal detection component configured to receive a respective signal of the respective wavelength; and a transmitter arm comprising a signal generator configured to provide a respective signal of the respective wavelength.

According to another aspect of the present disclosure, an optical network is provided. In an example embodiment, the optical network includes one or more photonic chips configured to be operated as a selective one of a bi-directional link chip or a co-directional link chip. The optical network is configured to be operated in a selected one of a bi-directional mode or a co-directional mode based at least in part on whether the one or more photonic chips are operated as bi-directional link chips or co-directional link chips.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic illustration of an example photonic circuit and/or chip, according to an example embodiment;

FIG. 2 is a schematic illustration of another example photonic circuit and/or chip, according to an example embodiment;

FIG. 3 is a schematic illustration of another example photonic circuit and/or chip, according to an example embodiment;

FIG. 4A illustrates an example optical network being operated in a bi-directional mode, according to an example embodiment;

FIG. 4B illustrates the example optical network shown in FIG. 4A being operated in a co-directional mode, according to example embodiment; and

FIG. 5 provides a flowchart illustrating various processes and/or procedures for operating an optical network, according to an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within engineering and/or manufacturing limits and/or within user measurement capabilities, unless otherwise indicated. Like numbers refer to like elements throughout.

### I. Overview

Optical networks are configured to communicate information via optical signals. For example, optical networks include components configured to generate and provide optical signals and components configured to receive optical signals. As data communication needs continue to increase, optical networks with higher bandwidths are desired. In order to accomplish such higher bandwidth systems, various optical network architectures are being developed and explored. These optical network architecture includes bi-directional links and co-directional links. When an optical link is operating in a bi-directional mode, the output signals and the input signals are carried by the same optical guide. When an optical link is operating in a co-directional mode, the output signals and the input signals are carried by two different optical guides.

Various embodiments provide photonic circuits and/or chips that are operable in both a bi-directional mode and a co-directional mode. For example, for each wavelength of the optical link, the photonic circuit and/or chip includes both a receiver arm and a transmitter arm. Tunable optical filters are used to tune the receiver arm corresponding to a respective wavelength (e.g., configured to receive signals of the respective wavelength) on or off. For example, the photonic circuit and/or chip includes at least one coupling waveguide configured to carry optical signals to and/or from the various arms of the photonic circuit and/or chip. The tunable optical filters may be used to control whether a receiver arm receives optical signals of a respective wavelength that are propagating through the at least one coupling waveguide.

For a receiver arm corresponding to a respective wavelength, the tunable optical filters may be tuned to pass the respective wavelength such that the receiver arm corresponding to the respective wavelength receives optical signals of the respective wavelength. In such an instance, the photonic circuit and/or chip may be used as a receiver for the respective wavelength.

When the tunable optical filters are tuned to not pass the respective wavelength, the receiver arm corresponding to the respective wavelength does not receive the optical signals of the respective wavelength. In such an instance, the photonic circuit and/or chip is not used as a receiver for the respective wavelength. For example, the photonic circuit and/or chip may be used as a transmitter for the respective wavelength.

Therefore, various embodiments enable the building of various optical networks and/or optical links that may operate in either a bi-directional mode or a co-directional mode using the same photonic circuits and/or chips.

Various optical network and/or optical link architectures are being developed and explored in order to develop optical networks and/or optical links with higher bandwidths and smaller formats than conventional optical networks and/or optical links. The architectures include bi-directional links and co-directional links. Conventional photonic circuits and/or chips are not capable of selective operation in a bi-directional and a co-directional mode. Therefore, technical challenges exist regarding photonic circuits and/or chips for use in such optical networks and/or links.

Various embodiments provide technical solutions to these technical problems. For example, various embodiments provide photonic circuits and/or chips including both a receiver arm and a transmitter arm for each wavelength of the optical link (e.g., two wavelengths, four wavelengths, or more). The receiver arms corresponding to respective wavelengths may be turned on or off individually such that the status of the photonic circuit and/or chip as a receiver for respective wavelengths may be individually controlled. In some embodiments, the transmitter arms corresponding to respective wavelengths may be turned on or off individually such that the status of the photonic circuit and/or chip as a transmitter for respective wavelengths may be individually controlled. This enables the photonic circuit and/or chip to be used as receiver for each wavelength of two or more wavelengths, used as a transmitter for each wavelength of two or more wavelengths, or used as a receiver for one or more wavelengths and a transmitter for the other one or more wavelengths. In other words, the photonic circuit and/or chip may be used as a co-directional receiver, a co-directional transmitter, or as a bi-directional circuit and/or chip. Optical networks and/or links may then be built using such photonic circuits and/or chips for operation in a bi-directional mode or a co-directional mode. Various embodiments therefore provide technical improvements in the field of optical networks and/or links and related fields.

### II. Example Photonic Circuits And/or Chips

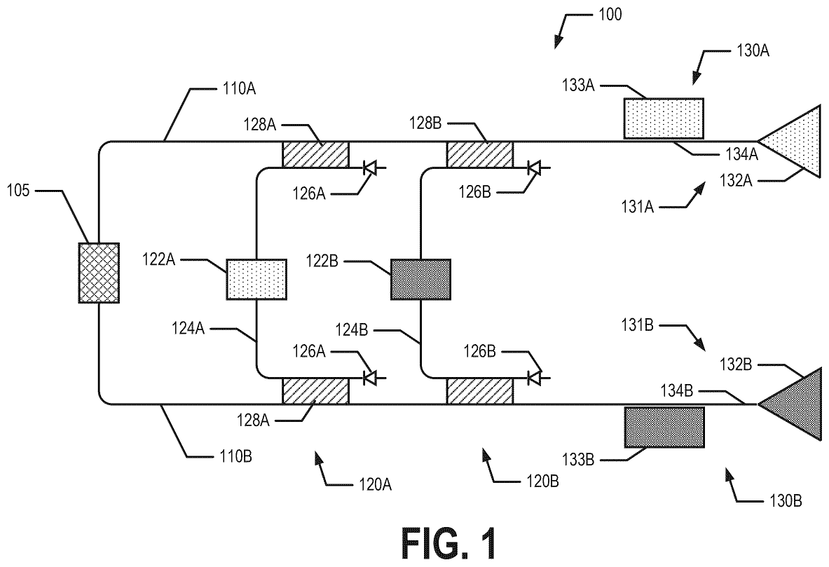

FIGS. 1, 2, and 3 illustrate various example embodiments of a photonic circuit and/or chip 100, 200, 300. The example photonic circuit and/or chip 100 is configured for use in an optical network and/or link using two wavelengths.

The photonic circuit and/or chip 100 includes a coupler 105 and at least one coupling waveguide 110 (e.g., 110A, 110B). The at least one coupling waveguide 110 are waveguides configured to propagate optical signals of the two or more wavelengths. The coupler 105 is configured to couple optical signals between an external optical guide (not shown) and the at least one coupling waveguide 110.

In various embodiments, the coupler 105 is a two-dimensional grating coupler. In an example embodiment, the at least one coupling waveguide 110 includes a first coupling waveguide 110A and a second coupling waveguide 110B. The coupler 105 is configured to receive an incoming optical signal (e.g., from an external optical guide) of an arbitrary polarization. The coupler 105 provides a first portion of the incoming optical signal having a first polarization (e.g., transverse electric (TE), for example) to a first coupling waveguide 110A and provides a second portion of the incoming optical signal having a second polarization (e.g., transverse magnetic (TM), for example) to a second coupling waveguide 110B. In various embodiments, the coupler 105 rotates the polarization of the second portion of the incoming optical signal to the first polarization, such that a rotated polarization signal (having the first polarization) is coupled into the second coupling waveguide 110B.

The photonic circuit and/or chip includes a first wavelength branch corresponding to a first wavelength. The first wavelength branch includes a first receiver arm 120A and a first transmitter arm 130A. The first receiver arm 120A comprises a first signal detection component 122A configured to detect signals of a first wavelength. In various embodiments, the first signal detection component 122A is a photodetector such as a photodiode. In an example embodiment, the first signal detection component 122A is a fast photodetector. For example, the first signal detection component 122A may have a rise time and/or a fall time appropriate for detecting optical signals transmitted in an optical network and/or link.

The first signal detection component is in optical communication with the first coupling waveguide 110A and the second coupling waveguide 110B via a receiver arm waveguide 124A and respective receiver filters 128A. The respective receiver filters 128A are tunable optical filters. For example, the receiver filters 128A may be tunable low pass filters, tunable high pass filters, or tunable bandpass filters, in various embodiments. In an example embodiment, the receiver filters 128A are tunable bandpass filters that may be tuned (e.g., via controlling a temperature thereof) to pass optical signals of the first wavelength or to not pass (e.g., block) optical signals of the first wavelength. For example, by tuning the receiver filters 128A, whether the first signal detection component 122A receives optical signals of the first wavelength is controlled. The receiver filters 128A that are in optical communication with the first receiver arm 120A are configured to not pass (e.g., block) optical signals of the second wavelength.

When the receiver filter 128A is tuned to pass the first wavelength, the first wavelength branch corresponding to the first wavelength is configured to act as a receiver. When the receiver filter 128A is tuned to not pass the first wavelength, the first wavelength branch corresponding to the first wavelength is configured to not act as a receiver. For example, when the receiver filter 128A is tuned to not pass the first wavelength, the first wavelength branch corresponding to the first wavelength is configured to as a transmitter.

The first transmitter arm 130A includes a first signal generator 131A configured to generate optical signals of the first wavelength. The first signal generator 131A is in optical communication with the first coupling waveguide 110A. In various embodiments, the first signal generator 131A includes a laser source 132A and a modulator 133A. For example, the laser source 132A may be on an on-chip laser configured to generate a laser beam characterized by the first wavelength. In another example, the laser source 132A is a coupler (e.g., a grating coupler and/or the like) configured to receive and couple a laser beam into a transmitter arm waveguide 134A. For example, an off-chip laser may be used to generate a laser beam characterized by the first wavelength and an optical guide (e.g., an optical fiber, waveguide, or optical path defined at least in part via free space optics) may be used to provide the laser beam characterized by the first wavelength to the laser source 132A (e.g., a coupler).

The modulator 133A is configured to modulate the laser beam in the transmitter arm waveguide 134A. For example, the modulator 133A may be a high-speed modulator such as a micro-ring modulator, electro-absorption modulator (EAM), Mach-Zehnder modulator (MZM), or other appropriate modulator. The modulator 133A is configured to modulate the laser beam in the transmitter arm waveguide 134A to encode information thereon. For example, the modulator 133A may modulate the laser beam in the transmitter arm waveguide 134A to generate an optical signal characterized by the first wavelength that carries information.

The photonic circuit and/or chip further includes a second wavelength branch corresponding to a second wavelength. The second wavelength branch includes a second receiver arm 120B and a second transmitter arm 130B. The second receiver arm 120B comprises a second signal detection component 122B configured to detect optical signals of a second wavelength. In various embodiments, the second signal detection component 122B is a photodetector, such as a photodiode for example. In an example embodiment, the second signal detection component 122B is a fast photodetector. For example, the second signal detection component 122B may have a rise time and/or a fall time appropriate for detecting optical signals transmitted in an optical network and/or link.

The second signal detection component 122B is in optical communication with the first coupling waveguide 110A and the second coupling waveguide 110B via a receiver arm waveguide 124B and respective receiver filters 128B. The respective receiver filters 128B are tunable optical filters. For example, the receiver filters 128B may be tunable low pass filters, tunable high pass filters, or tunable bandpass filters, in various embodiments. In an example embodiment, the receiver filters 128B are tunable bandpass filters that may be tuned (e.g., via controlling a temperature thereof) to pass optical signals of the second wavelength or to not pass (e.g., block) optical signals of the second wavelength. For example, by tuning the receiver filters 128B, whether the second signal detection component 122B receives optical signals of the second wavelength is controlled. The receiver filters 128B in optical communication with the second receiver arm 120B are configured to not pass (e.g., block) optical signals of the first wavelength.

When the receiver filter 128B is tuned to pass the second wavelength, the second wavelength branch corresponding to the second wavelength is configured to act as a receiver. When the receiver filter 128B is tuned to not pass the second wavelength, the second wavelength branch corresponding to the second wavelength is configured to not act as a receiver. For example, when the receiver filter 128B is tuned to not pass the second wavelength, the second wavelength branch corresponding to the second wavelength is configured to as a transmitter.

The second transmitter arm 130B includes a second signal generator 131B configured to generate optical signals of the second wavelength. The second signal generator 131B is in optical communication with the second coupling waveguide 110B. In various embodiments, the second signal generator 131B includes a laser source 132B and a modulator 133B. For example, the laser source 132B may be on an on-chip laser configured to generate a laser beam characterized by the second wavelength. In another example, the laser source 132B is a coupler (e.g., a grating coupler and/or the like) configured to receive and couple a laser beam into a transmitter arm waveguide 134B. For example, an off-chip laser may be used to generate a laser beam characterized by the second wavelength and an optical guide (e.g., an optical fiber, waveguide, or optical path defined at least in part via free space optics) may be used to provide the laser beam characterized by the second wavelength to the laser source 132B (e.g., a coupler).

The modulator 133B is configured to modulate the laser beam in the transmitter arm waveguide 134B. For example, the modulator 133B may be a high-speed modulator such as a micro-ring modulator, EAM, MZM, or other appropriate modulator. The modulator 133B is configured to modulate the laser beam in the transmitter arm waveguide 134B to encode information thereon. For example, the modulator 133B may modulate the laser beam in the transmitter arm waveguide 134B to generate an optical signal characterized by the second wavelength that carries information.

In some embodiments, the photonic circuit and/or chip 100 further includes control photodetectors 126A, 126B. In various embodiments, the control photodetectors 126A, 126B may be photodiodes configured to detect optical power of at least a respective one of the first wavelength and the second wavelength. For example, the control photodetectors 126A in optical communication with the receiver arm waveguide 124A of the first receiver arm 120A may be used to determine whether the receiver filters 128A configured to control optical communication of the first receiver arm 120A with the at least one coupling waveguide 110 are properly tuned. For example, when the receiver filters 128A are tuned to pass optical signals of the first wavelength, the control photodetectors 126A will detect the presence of an optical signal in the receiver arm waveguide 124A. When the receiver filters 128A are tuned to not pass (e.g., block) optical signals of the first wavelength, the control photodetectors 126A will not detect the presence of an optical signal in the receiver arm waveguide 124A. The control photodetectors 126B in optical communication with the receiver arm waveguide 124B of the second receiver arm 120B may be used to determine whether the receiver filters 128B configured to control optical communication of the second receiver arm 120B with the at least one coupling waveguide 110 are properly tuned.

In various embodiments, the coupler 105 coupling waveguides 110A, 110B, receiver filters 128A, 128B, components of the first receiver arm 120A, components of the second receiver arm 120B, components of the first transmitter arm 130A, and/or components of the second transmitter arm 130B are formed and/or disposed on a substrate, printed circuit board, computer chip, photonic integrated circuit (PIC), and/or other opto-electronic chip.

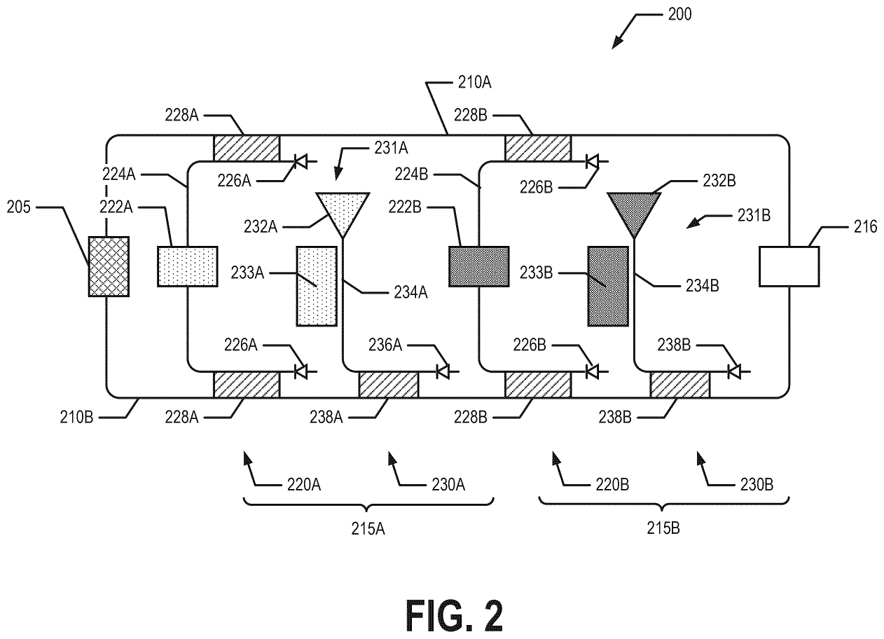

FIG. 2 illustrates another example embodiment of a photonic circuit and/or chip 200 configured for use with two wavelengths. The photonic circuit and/or chip 200 includes a coupler 205 and one or more coupling waveguides 210 (e.g., 210A, 210B). The first coupling waveguide 210A and the second coupling waveguide 210B are waveguides configured to propagate optical signals of the two wavelengths. The coupler 205 is configured to couple optical signals between an external optical guide (not shown) and the at least one coupling waveguide 210.

In various embodiments, the coupler 205 is a two-dimensional grating coupler. The coupler 205 is configured to receive an incoming optical signal (e.g., from an external optical guide) of an arbitrary polarization. The coupler 205 provides a first portion of the incoming optical signal having a first polarization (e.g., transverse electric (TE), for example) to a first coupling waveguide 210A and provides a second portion of the incoming optical signal having a second polarization (e.g., transverse magnetic (TM), for example) to a second coupling waveguide 210B. In various embodiments, the coupler 205 rotates the polarization of the second portion of the incoming optical signal to the first polarization, such that a rotated polarization signal (having the first polarization) is coupled into the second coupling waveguide 210B.

The photonic circuit and/or chip includes a wavelength branch 215 (e.g., 215A, 215B) corresponding to each wavelength of the two wavelengths. Each wavelength branch 215 includes a receiver arm 220 (e.g., 220A, 220B) and a transmitter arm 230 (e.g., 230A, 230B). The receiver arm 220 and transmitter arm 230 of a respective wavelength branch 215 are configured to receive and transmit, respectively, optical signals, of a wavelength corresponding to the wavelength branch 215.

Each receiver arm 220 comprises a respective signal detection component 222 (e.g., 222A, 222B) configured to detect signals of a respective wavelength. In various embodiments, the signal detection component 222 is a photodetector such as a photodiode. In an example embodiment, the signal detection component 222 is a fast photodetector. For example, the signal detection component 222 may have a rise time and/or a fall time appropriate for detecting optical signals transmitted in an optical network and/or link.

The signal detection component 222 is in optical communication with the first coupling waveguide 210A and the second coupling waveguide 210B via a respective receiver arm waveguide 224 (e.g., 224A, 224B) and respective receiver filters 228 (e.g., 228A, 228B). The respective receiver filters 228 are tunable optical filters. For example, the receiver filters 228 may be tunable low pass filters, tunable high pass filters, or tunable bandpass filters, in various embodiments. In an example embodiment, the receiver filters 228 are tunable bandpass filters that may be tuned (e.g., via controlling a temperature thereof) to pass optical signals of the respective wavelength or to not pass (e.g., block) optical signals of the respective wavelength. For example, by tuning the receiver filters 228 of a respective receiver arm 220, whether the corresponding signal detection component 222 receives optical signals of the respective wavelength is controlled. The receiver filters 228A that are in optical communication with the first receiver arm 220A are configured to not pass (e.g., block) optical signals of the second wavelength. The receiver filters 228B that are in optical communication with the second receiver arm 220B are configured to not pass (e.g., block) optical signals of the first wavelength.

When the receiver filter 228 of a wavelength branch corresponding to a respective wavelength is tuned to pass the respective wavelength, the wavelength branch corresponding to the respective wavelength is configured to act as a receiver (e.g., of optical signals characterized by the respective wavelength). When the receiver filter 228 of the wavelength branch corresponding to the respective wavelength is tuned to not pass the respective wavelength, the wavelength branch corresponding to the respective wavelength is configured to not act as a receiver (e.g., of optical signals characterized by the respective wavelength). For example, when the receiver filter 228 of the wavelength branch corresponding to the respective wavelength is tuned to not pass the respective wavelength, the wavelength branch corresponding to the respective wavelength is configured to as a transmitter (of optical signals characterized by the respective wavelength).

Each transmitter arm 230 (e.g., 230A, 230B) includes a signal generator 231 (e.g., 231A, 231B) configured to generate optical signals of the respective wavelength. In various embodiments, the signal generator 231 includes a respective laser source 232 (e.g., 232A, 232B) and a respective modulator 233 (e.g., 233A, 233B). For example, a laser source 232 may be on an on-chip laser configured to generate a laser beam characterized by a respective wavelength. In another example, a laser source 232 is a coupler (e.g., a grating coupler and/or the like) configured to receive and couple a laser beam into a transmitter arm waveguide 234 (e.g., 234A, 234B). For example, an off-chip laser may be used to generate a laser beam characterized by the respective wavelength and an optical guide (e.g., an optical fiber, waveguide, or optical path defined at least in part via free space optics) may be used to provide the laser beam characterized by the respective wavelength to the laser source 232 (e.g., a coupler).

The modulator 233 is configured to modulate the laser beam in the corresponding transmitter arm waveguide 234. For example, the modulator 233 may be a high-speed modulator such as a micro-ring modulator, EAM, MZM, or other appropriate modulator. The modulator 233 is configured to modulate the laser beam in the transmitter arm waveguide 234 to encode information thereon. For example, the modulator 233 may modulate the laser beam in the transmitter arm waveguide 234 to generate an optical signal characterized by the respective wavelength that carries information.

In various embodiments, the respective signal generators 231 of the transmitter arms 230 are in optical communication with at least one of the coupling waveguides 210A, 210B via a respective transmitter filter 238 (e.g., 238A, 238B). For example, whether the first transmitter arm 230A is in optical communication with a coupling waveguide 210 is controlled by a first transmitter filter 238A and whether the second transmitter arm 230B is in optical communication with a coupling waveguide 210 is controlled by a second transmitter filter 238B.

The respective transmitter filters 238 are tunable optical filters. For example, the transmitter filters 238 may be tunable low pass filters, tunable high pass filters, or tunable bandpass filters, in various embodiments. In an example embodiment, the transmitter filters 238 are tunable bandpass filters that may be tuned (e.g., via controlling a temperature thereof) to pass optical signals of the respective wavelength or to not pass (e.g., block) optical signals of the respective wavelength. For example, by tuning the transmitter filters 238 of a respective transmitter arm 230, whether optical signals generated by the respective signal generator 231 are passed to the coupling waveguide for transmission is controlled. The transmitter filter 238A that is in optical communication with the first transmitter arm 230A is configured to not pass (e.g., block) optical signals of the second wavelength. The transmitter filter 238B that is in optical communication with the second transmitter arm 230B are configured to not pass (e.g., block) optical signals of the first wavelength.

When the transmitter filter 238 of a wavelength branch corresponding to a respective wavelength is tuned to pass the respective wavelength, the wavelength branch corresponding to the respective wavelength is configured to act a transmitter (e.g., of optical signals characterized by the respective wavelength). When the transmitter filter 238 of the wavelength branch corresponding to the respective wavelength is tuned to not pass the respective wavelength, the wavelength branch corresponding to the respective wavelength is configured to not act as a transmitter (e.g., of optical signals characterized by the respective wavelength). Rather, for example, the wavelength branch corresponding to the respective wavelength may be configured to act as a receiver of optical signals characterized by the respective wavelength.

In some embodiments, the photonic circuit and/or chip 200 further includes control photodetectors 226 (e.g., 226A, 226B), 236, (e.g., 236A, 236B), 216. In various embodiments, the control photodetectors 226, 236, 216 may be photodiodes configured to detect optical power of at least one of the first wavelength and the second wavelength. For example, the control photodetectors 226A in optical communication with the receiver arm waveguide 224A of the first receiver arm 220A may be used to determine whether the receiver filters 228A configured to control optical communication of the first receiver arm 220A with the at least one coupling waveguide 210 are properly tuned. For example, when the receiver filters 228A are tuned to pass optical signals of the first wavelength, the control photodetectors 226A will detect the presence of an optical signal in the receiver arm waveguide 224A. When the receiver filters 228A are tuned to not pass (e.g., block) optical signals of the first wavelength, the control photodetectors 226A will not detect the presence of an optical signal in the receiver arm waveguide 224A. The control photodetectors 226B in optical communication with the receiver arm waveguide 224B of the second receiver arm 220B may be used to determine whether the receiver filters 228B configured to control optical communication of the second receiver arm 220B with the at least one coupling waveguide 210 are properly tuned.

For example, the control photodetectors 236A in optical communication with the transmitter arm waveguide 234A of the first transmitter arm 230A may be used to determine whether the transmitter filter 238A configured to control optical communication of the first transmitter arm 230A with the at least one coupling waveguide 210 is properly tuned. For example, when the transmitter filter 238A are tuned to pass optical signals of the first wavelength, an optical signal generated by the signal generator 231A will be passed to the coupling waveguide 210 via the transmitter filter 238A and the control photodetector 236A will not detect the presence of an (strong) optical signal in the transmitter arm waveguide 234A after the junction with the transmitter filter 238A. When the transmitter filter 238A is tuned to not pass (e.g., block) optical signals of the first wavelength, the control photodetectors 236A may detect the presence of an (strong) optical signal in the transmitter arm waveguide 234A after the junction with the transmitter filter 238A. The control photodetectors 236B in optical communication with the transmitter arm waveguide 234B of the second transmitter arm 230B may be used to determine whether the transmitter filter 238B configured to control optical communication of the second transmitter arm 230B with the at least one coupling waveguide 210 are properly tuned.

A circuit and/or chip level control photodetector 216 may be in optical communication with the one or more coupling waveguides 210 downstream of the junctions of the receiver filters 228 and transmitter filters 238 with the coupling waveguide(s) 210. The circuit and/or chip level control photodetector 216 may be used to determine whether the receiver filters and/or transmitter filters are acting as intended.

In various embodiments, the coupler 205 coupling waveguides 210A, 210B, receiver filters 228A, 228B, components of the first receiver arm 220A, components of the second receiver arm 220B, transmitter filters 238A, 238B, components of the first transmitter arm 230A, components of the second transmitter arm 230B, and/or circuit and/or chip level control photodetector 216 are formed and/or disposed on a substrate, printed circuit board, computer chip, PIC, and/or other opto-electronic chip.

In various embodiments, a photonic circuit and/or chip is configured for use with a plurality of wavelengths. For example, a photonic circuit and/or chip may be configured for use with two or more wavelengths. For example, the photonic circuit and/or chip may be configured for use with four wavelengths, six wavelengths, eight wavelengths, and/or the like, in various embodiments. For example, the photonic circuit and/or chip may be configured for use with a number of wavelengths corresponding to a course wavelength division multiplexing (CWDM) or dense wavelength division multiplexing (DWDM) protocol, in various embodiments.

For each wavelength that the photonic circuit and/or chip is configured for use, the photonic circuit and/or chip includes a respective wavelength branch that includes a receiver arm and a transmitter arm that may be selectively turned on or off. For example, receiver filters and/or transmitter filters may be used to control the optical communication between each receiver arm and the coupling waveguides and/or between each transmitter arm and the coupling waveguides. The optical communication between each receiver arm and/or transmitter arm and the coupling waveguide(s) is controlled independently (e.g., via respective tunable optical filters).

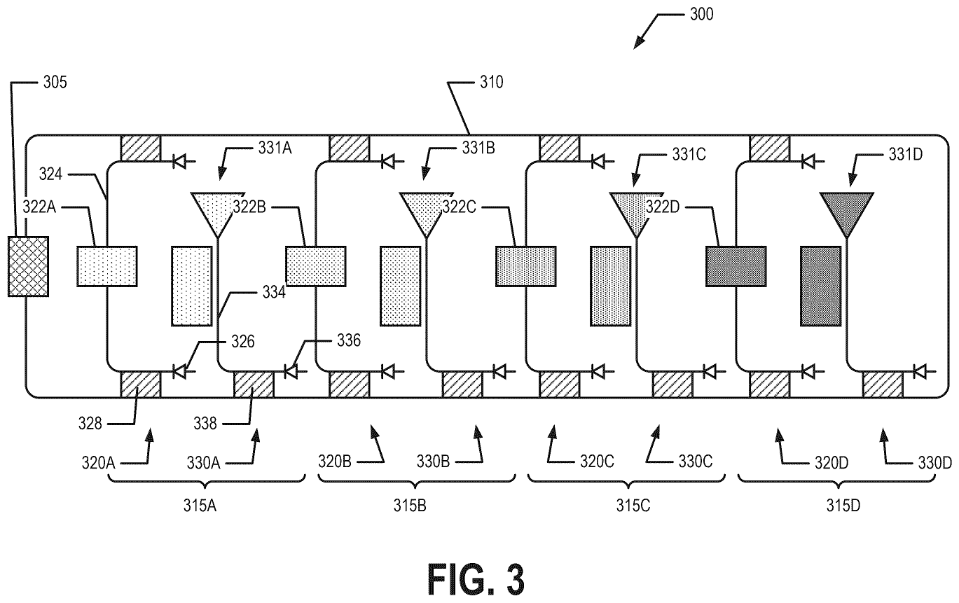

For example, FIG. 3 illustrates an example photonic circuit and/or chip 300 configured for use with four wavelengths. The photonic circuit and/or chip 300 includes four wavelength branches 315 (e.g., 315A, 315B, 315C, 315D) with each of the four wavelength branches corresponding to a respective wavelength of the four wavelengths. Each of the wavelength branches 315 includes a respective receiver arm 320 (e.g., 320A, 320B, 320C, 320D) and a respective transmitter arm 330 (e.g., 330A, 330B, 330C, 330D) in optical communication with the one or more coupling waveguides 310 via respective receiver filters 328 or transmitter filters 338. The receiver filters 328 and the transmitter filters 338 are tunable such that whether a respective receiver arm 320 or a respective transmitter arm 330 is in optical communication with the coupling waveguide(s) 310 or not is individually controllable via the tuning of the respective filter(s).

The photonic circuit and/or chip 300 includes a coupler 305 and one or more coupling waveguides 310. The one or more coupling waveguides 310 are waveguides configured to propagate optical signals of the four wavelengths. The coupler 305 is configured to couple optical signals between an external optical guide (not shown) and the one or more coupling waveguides 310.

In various embodiments, the coupler 305 is a two-dimensional grating coupler. The coupler 305 is configured to receive an incoming optical signal (e.g., from an external optical guide) of an arbitrary polarization. The coupler 305 provides a first portion of the incoming optical signal having a first polarization (e.g., transverse electric (TE), for example) to a first coupling waveguide 310 and provides a second portion of the incoming optical signal having a second polarization (e.g., transverse magnetic (TM), for example) to a second coupling waveguide 310. In various embodiments, the coupler 305 rotates the polarization of the second portion of the incoming optical signal to the first polarization, such that a rotated polarization signal (having the first polarization) is coupled into the second coupling waveguide 310.

The photonic circuit and/or chip includes a wavelength branch 315 (e.g., 315A, 315B, 315C, 315D) corresponding to each wavelength of the four wavelengths. Each wavelength branch 315 includes a receiver arm 320 (e.g., 320A, 320B, 320C, 320D) and a transmitter arm 330 (e.g., 330A, 330B, 330C, 330D). The receiver arm 320 and transmitter arm 330 of a respective wavelength branch 315 are configured to receive and transmit, respectively, optical signals, of a wavelength corresponding to the wavelength branch 315.

Each receiver arm 320 comprises a respective signal detection component 322 (e.g., 322A, 322B, 322C, 322D) configured to detect signals of a respective wavelength. In various embodiments, the signal detection component 322 is a photodetector such as a photodiode. In an example embodiment, the signal detection component 322 is a fast photodetector. For example, the signal detection component 322 may have a rise time and/or a fall time appropriate for detecting optical signals transmitted in an optical network and/or link.

The signal detection component 322 is in optical communication with the first coupling waveguide 210A and the second coupling waveguide 210B via a respective receiver arm waveguide 324 and respective receiver filters 328. The respective receiver filters 328 are tunable optical filters. In an example embodiment, the receiver filters 328 are tunable bandpass filters that may be tuned (e.g., via controlling a temperature thereof) to pass optical signals of the respective wavelength or to not pass (e.g., block) optical signals of the respective wavelength. For example, by tuning the receiver filters 328 of a respective receiver arm 320, whether the corresponding signal detection component 322 receives optical signals of the respective wavelength is controlled. The receiver filters 328 that are in optical communication with a particular receiver arm 320 corresponding to a respective wavelength are configured to not pass (e.g., block) optical signals of the remainder of the four wavelengths (e.g., the wavelengths of the four wavelengths other than the respective wavelength).

When the receiver filter 328 of a wavelength branch corresponding to a respective wavelength is tuned to pass the respective wavelength, the wavelength branch corresponding to the respective wavelength is configured to act as a receiver (e.g., of optical signals characterized by the respective wavelength). When the receiver filter 328 of the wavelength branch corresponding to the respective wavelength is tuned to not pass the respective wavelength, the wavelength branch corresponding to the respective wavelength is configured to not act as a receiver (e.g., of optical signals characterized by the respective wavelength). For example, when the receiver filter 328 of the wavelength branch corresponding to the respective wavelength is tuned to not pass the respective wavelength, the wavelength branch corresponding to the respective wavelength is configured to as a transmitter (of optical signals characterized by the respective wavelength).

Each transmitter arm 330 includes a signal generator 331 (e.g., 331A, 331B, 331C, 331D) configured to generate optical signals of the respective wavelength. In various embodiments, the signal generator 331 includes a respective laser source and a respective modulator. For example, a laser source may be on an on-chip laser configured to generate a laser beam characterized by a respective wavelength. In another example, a laser source is a coupler (e.g., a grating coupler and/or the like) configured to receive and couple a laser beam into a transmitter arm waveguide 334. For example, an off-chip laser may be used to generate a laser beam characterized by the respective wavelength and an optical guide (e.g., an optical fiber, waveguide, or optical path defined at least in part via free space optics) may be used to provide the laser beam characterized by the respective wavelength to the laser source (e.g., a coupler).

The modulator is configured to modulate the laser beam in the corresponding transmitter arm waveguide 334. For example, the modulator may be a high-speed modulator such as a micro-ring modulator, EAM, MZM, or other appropriate modulator. The modulator is configured to modulate the laser beam in the transmitter arm waveguide 334 to encode information thereon. For example, the modulator may modulate the laser beam in the transmitter arm waveguide 334 to generate an optical signal characterized by the respective wavelength that carries information.

In various embodiments, the respective signal generators 331 of the transmitter arms 330 are in optical communication with at least one of the coupling waveguides 310 via a respective transmitter filter 338. The respective transmitter filters 338 are tunable optical filters. In an example embodiment, the transmitter filters 338 are tunable bandpass filters that may be tuned (e.g., via controlling a temperature thereof) to pass optical signals of the respective wavelength or to not pass (e.g., block) optical signals of the respective wavelength. For example, by tuning the transmitter filters 338 of a respective transmitter arm 330, whether optical signals generated by the respective signal generator 331 are passed to the coupling waveguide 310 for transmission is controlled. The transmitter filter 338 that is in optical communication with a particular transmitter arm 330 corresponding to a respective wavelength may be configured to not pass (e.g., block) optical signals of the remainder of the four wavelengths (e.g., to block the wavelengths of the four wavelengths other than the respective wavelength).

When the transmitter filter 338 of a wavelength branch corresponding to a respective wavelength is tuned to pass the respective wavelength, the wavelength branch corresponding to the respective wavelength is configured to act a transmitter (e.g., of optical signals characterized by the respective wavelength). When the transmitter filter 338 of the wavelength branch corresponding to the respective wavelength is tuned to not pass the respective wavelength, the wavelength branch corresponding to the respective wavelength is configured to not act as a transmitter (e.g., of optical signals characterized by the respective wavelength). Rather, for example, the wavelength branch corresponding to the respective wavelength may be configured to act as a receiver of optical signals characterized by the respective wavelength.

In some embodiments, the photonic circuit and/or chip 300 further includes control photodetectors 326, 336. In various embodiments, the control photodetectors 326, 336 may be photodiodes configured to detect optical power of at least one of the plurality of wavelengths the photonic circuit and/or chip is configured for use with. For example, the control photodetectors 326 in optical communication with a receiver arm waveguide 324 of a particular receiver arm 320 may be used to determine whether the receiver filters 328 configured to control optical communication of the particular receiver arm 320 with the at least one coupling waveguide 310 are properly tuned. For example, when the receiver filters 328 are tuned to pass optical signals of the respective wavelength, the control photodetectors 326 will detect the presence of an optical signal in the receiver arm waveguide 324 of the particular receiver arm 320. When the receiver filters 328 are tuned to not pass (e.g., block) optical signals of the respective wavelength, the control photodetectors 326 in optical communication with the receiver arm waveguide 324 of the particular receiver arm 320 will not detect the presence of an optical signal in the receiver arm waveguide 324.

For example, the control photodetectors 336 in optical communication with the transmitter arm waveguide 334 of a particular transmitter arm 330 may be used to determine whether the transmitter filter 338 configured to control optical communication of the particular transmitter arm 330 with the at least one coupling waveguide 310 is properly tuned. For example, when the transmitter filter 338 are tuned to pass optical signals of the respective wavelength, an optical signal generated by the signal generator 331 will be passed to the coupling waveguide 310 via the transmitter filter 338 and the control photodetector 336 will not detect the presence of an (strong) optical signal in the transmitter arm waveguide 334 after the junction with the transmitter filter 338. When the transmitter filter 338 is tuned to not pass (e.g., block) optical signals of the respective wavelength, the control photodetector 336 may detect the presence of an (strong) optical signal in the transmitter arm waveguide 334 of the particular transmitter arm 330 after the junction with the transmitter filter 338.

In various embodiments, the coupler 305, coupling waveguides 310, receiver filters 328, components of the receiver arms 320A, 320B, 320C, 320D, transmitter filters 238A, 338, and/or components of the transmitter arms 330A, 330B, 330C, 330D are formed and/or disposed on a substrate, printed circuit board, computer chip, PIC, and/or other opto-electronic chip.

### III. Example Optical Networks

Photonic circuits and/or chips 100, 200, 300 may be incorporated into various optical networks and/or links. For example, photonic circuit and/or chips 300 may be incorporated into various optical networks and/or links configured for use with course wavelength division multiplexing (CWDM) and/or dense wavelength division multiplexing (DWDM) protocols. In various embodiments, photonic circuits and/or chips 100, 200, 300 may be incorporated into various optical networks and/or links configured for operation in a bi-directional mode or in a co-directional mode.

For example, in various embodiments an optical network and/or link may include two or more photonic circuits and/or chips 100, 200, 300 configured to be operated in a selected one of a bi-directional mode or a co-directional mode. For example, the receiver filters 128, 228, 328 and/or the transmitter filters 238, 338 of the two or more photonic circuits and/or chips 100, 200, 300 may be tuned such that the two or more photonic circuits and/or chips are operated as a selected one of bi-directional link chips or co-directional link chips. For example, the optical network and/or link is configured to be operated in a selected one of a bi-directional mode or a co-directional mode based at least in part on whether the one or more photonic circuits and/or chips are operated as bi-directional link chips or co-directional link chips.

In various embodiments, the optical network and/or link may further include one or more optical guides configured to place the two or more photonic circuits and/or chips 100, 200, 300 in optical communication with one another. In various embodiments, the optical guides may be optical fibers, waveguides, and/or optical paths that are defined at least in part by free space optics. For example, the optical guides may place the coupler 105, 205, 305 of one photonic circuit and/or chip 100, 200, 300 of the optical network and/or link into optical communication with the coupler 105, 205, 305 of another photonic circuit and/or chip 100, 200, 300 of the optical network.

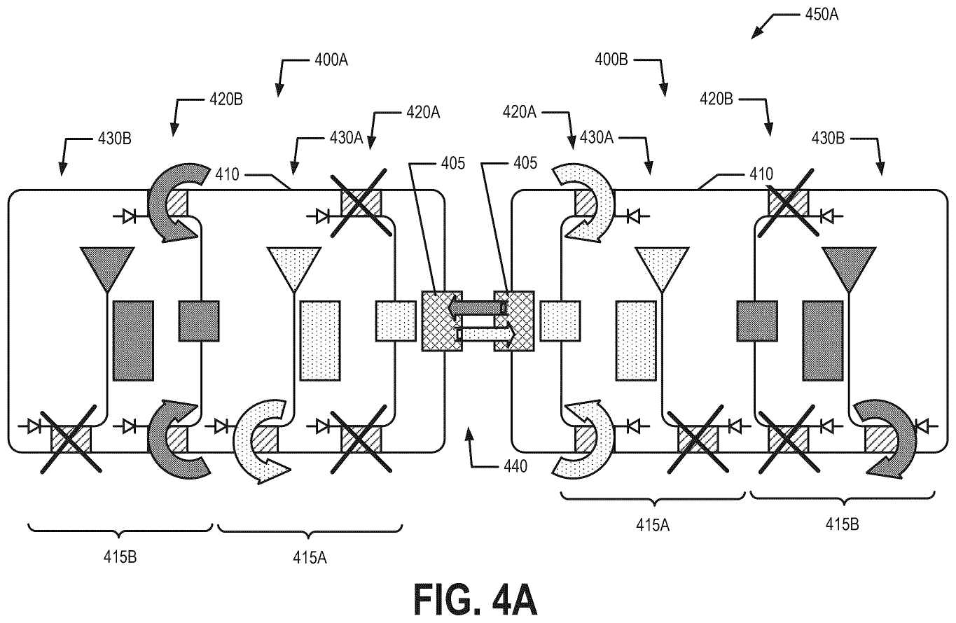

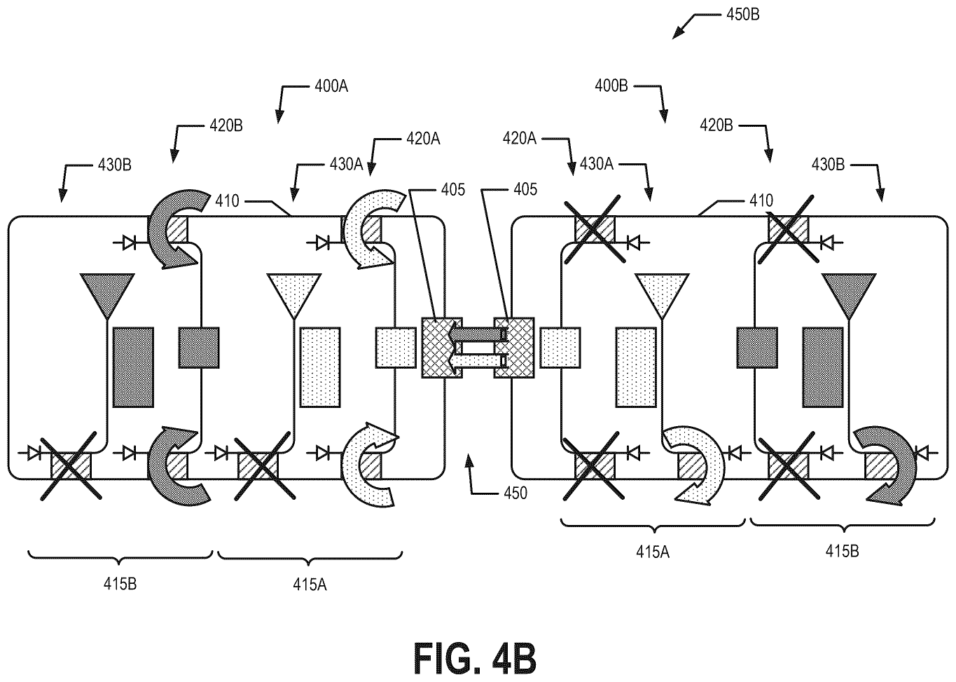

FIG. 4A provides a schematic diagram of an example optical network and/or link 450A comprising a first photonic circuit and/or chip 400A, a second photonic circuit and/or chip 400B, and one or more optical guides 440. The optical network and/or link 450A is configured for operation in a bi-directional mode. FIG. 4B provides a schematic diagram of an optical network and/or link 450B comprising the first photonic circuit and/or chip 400B, the second photonic circuit and/or chip 400B, and the one or more optical guides 440. The optical network and/or link 450B is configured for operation in a co-directional mode. In FIGS. 4A and 4B, the arrows on the receiver filters and the transmitter filters indicate receiver filters and transmitter filters that are tuned to pass the respective wavelength corresponding to that wavelength branch and the X's on the receiver filters and transmitter filters indicate receiver filters and transmitter filters that are tuned to no pass (e.g., block) the respective wavelength corresponding to that wavelength branch.

The photonic circuits and/or chips 400A, 400B each comprise a first wavelength branch 415A and a second wavelength branch 415B. Each wavelength branch 415 (e.g., 415A, 415B) comprises a receiver arm 420 (420A, 420B) and a transmitter arm 430 (e.g., 430A, 430B). Each receiver arm 420 includes a respective signal detection component that is selectively in communication with the coupling waveguide(s) 410 of the photonic circuit and/or chip via one or more receiver filters. Each transmitter arm 430 includes a respective signal generation component that is selectively in communication with the coupling waveguide 410 via one or more transmitter filters. Each of the photonic circuits and/or chips 400A, 400B includes a coupler 405 configured to couple optical signals from the optical guide(s) 440 into the coupling waveguide 410 and/or to couple optical signals from the coupling waveguide 410 into the optical guide(s) 440. For example, the couplers 405 of the photonic circuits and/or chips 400A, 400B are in optical communication with one another via the optical guide(s) 440.

As shown in FIG. 4A, in the bi-directional mode optical circuit and/or link 450A, the photonic circuit and/or chip 400A is configured to operate the first wavelength branch 415A as a transmitter for optical signals of a first wavelength and configured to operate the second wavelength branch 415B as a receiver for optical signals of a second wavelength. In particular, the receiver filters of the receiver arm 420A of the first wavelength branch 415A are tuned to not pass (e.g., block) optical signals of the first wavelength (and to block optical signals of the second wavelength). The transmitter filters of the transmitter arm 430A of the first wavelength branch 415A are tuned to pass optical signals of the first wavelength. Thus, the first wavelength branch 415A is operated as a transmitter of optical signals of the first wavelength.

The receiver filters of the receiver arm 420B of the second wavelength branch 415B are tuned to pass optical signals of the second wavelength and the transmitter filters of the transmitter arm 430B are tuned to not pass (e.g., block) optical signals of the second wavelength. Thus, the second wavelength branch 415B is operated as a receiver of optical signals of the second wavelength.

The photonic circuit and/or chip 400B is configured to operate as a receiver of optical signals of the first wavelength and a transmitter of optical signals of the second wavelength. For example, the receiver filters of the receiver arm 420A of the first wavelength branch 415A are tuned to pass optical signals of the first wavelength (and to block optical signals of the second wavelength). The transmitter filters of the transmitter arm 430A of the first wavelength branch 415A are tuned to not pass (e.g., block) optical signals of the first wavelength. Thus, the first wavelength branch 415A is operated as a receiver of optical signals of the first wavelength. The receiver filters of the receiver arm 420B of the second wavelength branch 415B are tuned to not pass (e.g., block) optical signals of the second wavelength and the transmitter filters of the transmitter arm 430B are tuned to pass optical signals of the second wavelength. Thus, the second wavelength branch 415B is operated as a transmitter of optical signals of the second wavelength.

In the optical network and/or link 450A, optical signals of the first wavelength are communicated from left to right and optical signals of the second wavelength are communicated from right to left, such that the optical network and/or link 450A is configured to operate in a bi-directional mode based on the configuration of the photonic circuits and/or chips 400A, 400B.

The optical network and/or link 450B illustrated in FIG. 4B illustrates the same photonic circuits and/or chips 400A, 400B configured for operation as co-directional link chips. As a result thereof, the optical network and/or link 450B is operated as a co-directional optical network and/or link where optical signals of the first wavelength and optical signals of the second wavelength are both communicated from right to left (in the illustrated embodiment).

As shown in FIG. 4B, in the co-directional mode optical circuit and/or link 450B, the photonic circuit and/or chip 400A is configured to operate as a co-directional receiver photonic circuit and/or chip. In particular, the first wavelength branch 415A and the second wavelength branch 415B are configured to operate as receivers of optical signals of respective wavelengths. For example, the receiver filters of the receiver arm 420A of the first wavelength branch 415A are tuned to pass optical signals of the first wavelength (and to block optical signals of the second wavelength). The transmitter filters of the transmitter arm 430A of the first wavelength branch 415A are tuned to not pass (e.g., block) optical signals of the first wavelength. Thus, the first wavelength branch 415A is operated as a receiver of optical signals of the first wavelength. The receiver filters of the receiver arm 420B of the second wavelength branch 415B are tuned to pass optical signals of the second wavelength and the transmitter filters of the transmitter arm 430B are tuned to not pass (e.g., block) optical signals of the second wavelength. Thus, the second wavelength branch 415B is operated as a receiver of optical signals of the second wavelength.

The photonic circuit and/or chip 400B is configured to operate as a transmitter of optical signals of the first wavelength and of the second wavelength. For example, the receiver filters of the receiver arm 420A of the first wavelength branch 415A are tuned to not pass (e.g., block) optical signals of the first wavelength (and to block optical signals of the second wavelength). The transmitter filters of the transmitter arm 430A of the first wavelength branch 415A are tuned to pass optical signals of the first wavelength. Thus, the first wavelength branch 415A is operated as a transmitter of optical signals of the first wavelength. The receiver filters of the receiver arm 420B of the second wavelength branch 415B are tuned to not pass (e.g., block) optical signals of the second wavelength and the transmitter filters of the transmitter arm 430B are tuned to pass optical signals of the second wavelength. Thus, the second wavelength branch 415B is operated as a transmitter of optical signals of the second wavelength.

In various embodiments, optical networks and/or links configured for operation in a bi-directional mode or a co-directional mode may use various numbers of wavelengths. For example, an optical network and/or link may comprise two or more photonic circuits and/or chips comprising a plurality of wavelength branches (each comprising a respective receiver arm and a respective transmitter arm that may be selectively placed into optical communication with the coupling waveguide(s) of the respective photonic circuit and/or chip) each configured for use as a receiver or a transmitter for optical signals characterized by a respective wavelength of a plurality of wavelengths.

In various embodiments, the coupler 405, coupling waveguides 410, and components of the wavelength branches 415A, 415B of the optical circuits and/or chips 400A, 440B are formed and/or disposed on respective substrates, printed circuit boards, computer chips, PICs, and/or other opto-electronic chips.

### IV. Example Method of Operating an Optical Network

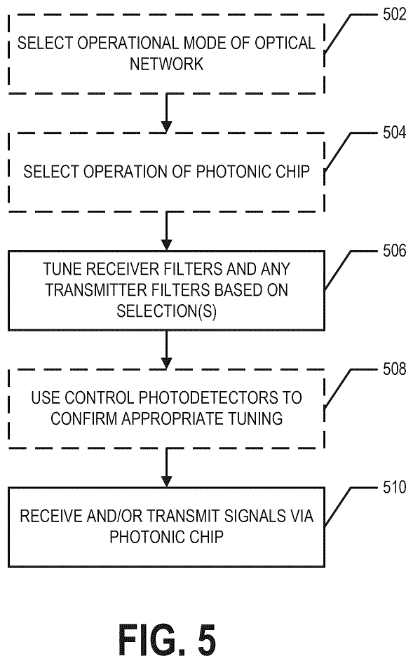

FIG. 5 provides a flowchart illustrating various process and/or procedures for operating an optical network and/or link comprising two or more photonic circuits and/or chips 100, 200, 300, 400 that are in optical communication with one another via one or more optical guides.

Starting at step 502, an operational mode of the optical network and/or link is selected. For example, a technician or designer of the optical network and/or link may select an operational mode for the optical network and/or link. For example, the technician and/or designer of the optical network and/or link may determine and/or select whether the optical network and/or link is to be operated as a bi-directional link or a co-directional link.

At step 504, for each photonic circuit and/or chip 100, 200, 300, 400 of the optical network and/or link, the operation of the photonic circuit and/or chip is selected, designated, and/or determined. For example, a technician or design of the optical network and/or link may select, designate, and/or determine an operation of each photonic circuit and/or chip of the optical network and/or link. For example, for a co-directional optical network and/or link including two photonic circuits and/or chips, one of the photonic circuits and/or chips is designated as a co-directional receiver chip and the other of the photonic circuits and/or chips is designated as a co-directional transmitter chip.

For example, for a bi-directional optical network and/or link including two photonic circuits and/or chips, one of the photonic circuits and/or chips is designated as a receiver chip for a first sub-set of a plurality of wavelengths and as a transmitter chip for a second sub-set of the plurality of wavelengths. The intersection of the first sub-set and the second sub-set is empty and the union of the first sub-set and the second sub-set is the plurality of wavelengths. The other of the photonic circuits and/or chips is designated as a receiver chip for the second sub-set of the plurality of wavelengths and as a transmitter chip for the first sub-set of the plurality of wavelengths.

At step 506, the receiver filters and any transmitter filters of each of the photonic circuits and/or chips are tuned based on the operation selected, designated and/or determined for the respective photonic circuit and/or chip.

For example, for the bi-directional optical network and/or link 450A, the receiver filters and the transmitter filters of the first photonic circuit and/or chip 400A are tuned such that the first wavelength branch 415A functions as a transmitter of optical signals of the first wavelength and the second wavelength branch 415B functions as a receiver of optical signals of the second wavelength. For example, the receiver filters of the first receiver arm 420A are tuned to not pass (e.g., block) optical signals of the first wavelength, the transmitter filters of the first transmitter arm 430A are tuned to pass optical signals of the first wavelength, the receiver filters of the second receiver arm 420B are tuned to pass optical signals of the second wavelength, and the transmitter filters of the second transmitter arm 430B are tuned to not pass (e.g., block) optical signals of the second wavelength. The receiver filters and the transmitter filters of the second photonic circuit and/or chip 400B are tuned such that the first wavelength branch 415A functions as a receiver of optical signals of the first wavelength and the second wavelength branch 415B functions as a transmitter of optical signals of the second wavelength. For example, the receiver filters of the first receiver arm 420A are tuned to pass optical signals of the first wavelength, the transmitter filters of the first transmitter arm 430A are tuned to not pass (e.g., block) optical signals of the first wavelength, the receiver filters of the second receiver arm 420B are tuned to not pass (e.g., block) optical signals of the second wavelength, and the transmitter filters of the second transmitter arm 430B are tuned to pass optical signals of the second wavelength.

In another example, for the co-directional optical network and/or link 450B, the receiver filters and the transmitter filters of the first photonic circuit and/or chip 400A are tuned such that the first wavelength branch 415A functions as a receiver of optical signals of the first wavelength and the second wavelength branch 415B functions as a receiver of optical signals of the second wavelength. For example, the receiver filters of the first receiver arm 420A are tuned to pass optical signals of the first wavelength, the transmitter filters of the first transmitter arm 430A are tuned to not pass (e.g., block) optical signals of the first wavelength, the receiver filters of the second receiver arm 420B are tuned to pass optical signals of the second wavelength, and the transmitter filters of the second transmitter arm 430B are tuned to not pass (e.g., block) optical signals of the second wavelength. The receiver filters and the transmitter filters of the second photonic circuit and/or chip 400B are tuned such that the first wavelength branch 415A functions as a transmitter of optical signals of the first wavelength and the second wavelength branch 415B functions as a transmitter of optical signals of the second wavelength. For example, the receiver filters of the first receiver arm 420A are tuned to not pass (e.g., block) optical signals of the first wavelength, the transmitter filters of the first transmitter arm 430A are tuned to pass optical signals of the first wavelength, the receiver filters of the second receiver arm 420B are tuned to not pass (e.g., block) optical signals of the second wavelength, and the transmitter filters of the second transmitter arm 430B are tuned to pass optical signals of the second wavelength.

In various embodiments, tuning the receiver filters and any transmitter filters may include setting a temperature of the respective optical filters. For example, a heater of a respective filter may be set to a particular value and/or configured for operation with a particular control current configured to maintain the respective filter at a temperature that provides the desired filtering (e.g., passing or not passing of a respective wavelength).

At step 508, the appropriate tuning of the receiver filters and any transmitter filters may be confirmed via the control photodetectors. For example, a control photodetectors 226, 326 in optical communication with a receiver arm waveguide 224, 324 of a receiver arm 220, 320 may be used to determine whether the receiver filters 228, 328 configured to control optical communication of the receiver arm 220, 320 with the at least one coupling waveguide 210, 310 are properly tuned. For example, when the receiver filters 228 are tuned to pass optical signals of the respective wavelength, the control photodetectors 226, 326 will detect the presence of an optical signal in the receiver arm waveguide 224, 324. When the receiver filters 228 are tuned to not pass (e.g., block) optical signals of the respective wavelength, the control photodetectors 226, 326 will not detect the presence of an optical signal in the receiver arm waveguide 224, 324.

In another example, the control photodetectors 236, 336 in optical communication with the transmitter arm waveguide 234, 334 of a transmitter arm 230, 330 may be used to determine whether the transmitter filter 238, 338 configured to control optical communication of the transmitter arm 230, 330 with the at least one coupling waveguide 210, 310 is properly tuned. For example, when the transmitter filter 238, 338 is tuned to pass optical signals of the respective wavelength, an optical signal generated by the signal generator 231, 331 will be passed to the coupling waveguide 210, 310 via the transmitter filter 238, 338 and the control photodetector 236, 336 will not detect the presence of an (strong) optical signal in the transmitter arm waveguide 234, 334 after the junction of the transmitter arm waveguide 234, 334 with the transmitter filter 238, 338. When the transmitter filter 238, 338 is tuned to not pass (e.g., block) optical signals of the respective wavelength, the control photodetectors 236, 336 may detect the presence of an (strong) optical signal in the transmitter arm waveguide 234, 334 after the junction of the transmitter arm waveguide 234, 334 with the transmitter filter 238, 338 (for example, when the signal generator is caused to generate a signal).

In some embodiments, a circuit and/or chip level control photodetector 216 is in optical communication with the one or more coupling waveguides 210 downstream of the junctions of the receiver filters 228 and transmitter filters 238 with the coupling waveguide(s) 210. The circuit and/or chip level control photodetector 216 may be used to determine whether the receiver filters and/or transmitter filters are acting as intended.

Therefore, by monitoring the signals detected by the control photodetectors 226, 236, 216, 326, 336 present in the photonic circuit and/or chip and comparing the detected signals to expectations, it may be determined if the receiver filters and any transmitter filters are operating as intended. For example, if the tuning of a receiver filter or a transmitter filter wanders over time, the wandering of the tuning may be detected via monitoring of the detected signals and the tuning of the receiver filter or the transmitter filter may be adjusted and/or corrected.

At step 510, one or more optical signals are received and/or transmitted via the photonic circuits and/or chips 100, 200, 300, 400 of the optical network and/or link. For example, any wavelength branches of the photonic circuits and/or chips of the optical network and/or link that are configured (e.g., via tuning of the receiver filters and any transmitter filters) to act as receivers of optical signals of respective wavelengths are used to receive optical signals of the respective wavelengths. In another example, any wavelength branches of the photonic circuits and/or chips of the optical network and/or link that are configured (e.g., via tuning of the receiver filters and any transmitter filters) to act as transmitters of optical signals of respective wavelengths are used to transmit optical signals of the respective wavelengths. For example, the optical network and/or link may be used to communicate information, transmit and receive optical communications, and/or the like.

In various embodiments, steps 508 and 510 may be performed repeatedly and/or continuously for a period of time. In some embodiments, steps 508 and 510 may be performed in various orders, simultaneously, and/or at least partially overlapping in time.

### V. Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A photonic circuit comprising:
at least one coupling waveguide;
two or more receiver filters that are each a tunable bandpass filter; and
two or more wavelength branches, each wavelength branch of the two or more wavelength branches corresponding to a respective wavelength, each wavelength branch of the two or more wavelength branches comprising:
a receiver arm comprising a signal detection component, the receiver arm selectively in optical communication with the at least one coupling waveguide via a receiver filter of the two or more receiver filters; and
a transmitter arm comprising a signal generator configured to provide a transmission signal to the at least one coupling waveguide,
wherein the photonic circuit is configured for selective use as a bi-directional link or a co-directional link,
wherein when the receiver filter is tuned to pass the respective wavelength, the wavelength branch corresponding to the respective wavelength is configured to act as a receiver, and
wherein when the receiver filter is tuned to not pass the respective wavelength, the wavelength branch corresponding to the respective wavelength is configured to not act as a receiver.

2. The photonic circuit of claim 1, wherein when the receiver filter is tuned to not pass the respective wavelength, the wavelength branch corresponding to the respective wavelength is configured to as a transmitter.

3. The photonic circuit of claim 1, further comprising:
two or more transmitter filters, the two or more transmitter filters each being a tunable bandpass filter, the transmitter arm in optical communication with the at least one coupling waveguide via a transmitter filter of the two or more transmitter filters,
wherein when the transmitter filter is tuned to pass the respective wavelength, the wavelength branch corresponding to the respective wavelength is configured to act a transmitter, and
wherein when the transmitter filter is tuned to not pass the respective wavelength, the wavelength branch corresponding to the respective wavelength is configured to not act as a transmitter.

4. The photonic circuit of claim 3, wherein the transmitter arm comprises a transmitter arm waveguide configured to optically couple the signal generator to the transmitter filter.

5. The photonic circuit of claim 4, further comprising a control photodetector in communication with the transmitter arm waveguide, the transmitter filter being disposed between the control photodetector and the signal generator.

6. The photonic circuit of claim 1, further comprising a coupler in optical communication with the at least one coupling waveguide, the coupler configured to couple signals into and out of the photonic circuit.

7. The photonic circuit of claim 6, wherein the coupler is a two-dimensional grating coupler.

8. The photonic circuit of claim 7, wherein the at least one coupling waveguide comprises two coupling waveguides, the coupler is configured to provide signals having a first polarization to a first coupling waveguide of the two coupling waveguides, and the coupler is configured to rotate a polarization of signals having a second polarization to the first polarization and provide a rotated polarization signal to a second coupling waveguide of the two coupling waveguides.

9. The photonic circuit of claim 8, wherein the receiving arm is in optical communication with the first coupling waveguide via a first receiver filter and in optical communication with the second coupling waveguide via a second receiver filter.

10. The photonic circuit of claim 1, wherein the signal detection component comprises a photodiode configured to detect an optical signal of the respective wavelength.

11. The photonic circuit of claim 1, wherein the signal generator comprises a laser configured to generate an optical beam of the respective wavelength and a modulator configured to modulate the optical beam to generate an optical signal of the respective wavelength.

12. The photonic circuit of claim 1, wherein the two or more wavelength branches are one of two wavelength branches or four wavelength branches.

13. The photonic circuit of claim 1, further comprising a control photodetector in optical communication with the at least one coupling waveguide downstream of the two or more wavelength branches, the control photodetector configured to detect whether a residual optical signal is present in the at least one coupling waveguide downstream of the two or more wavelength branches.

14. The photonic circuit of claim 1, wherein the receiver arm comprises a receiver arm waveguide configured to optically couple the signal detection component to the receiver filter.

15. The photonic circuit of claim 14, further comprising a control photodetector in communication with the receiver arm waveguide, the receiver filter being disposed between the control photodetector and the signal detection component.

16. The photonic circuit of claim 1, wherein the two or more wavelength branches consist of four wavelength branches.

17. The photonic circuit of claim 1, wherein the photonic circuit is configured for use in an optical network using course wavelength division multiplexing (CWDM) or dense wavelength division multiplexing (DWDM).

18. A photonic circuit comprising:
a first coupling waveguide and a second coupling waveguide;
a first receiver arm comprising a first signal detection component, the first receiver arm in optical communication with the first coupling waveguide and the second coupling waveguide via a first pair of receiver filters, wherein the first receiver arm corresponds to a first wavelength;
a second receiver arm comprising a second signal detection component, the second receiver arm in optical communication with the first coupling waveguide and the second coupling waveguide via a second pair of receiver filters, wherein the second receiver arm corresponds to a second wavelength;
a first transmitter arm comprising a first signal generator configured to generate optical signals of the first wavelength, the first transmitter arm in optical communication with at least one of the first coupling waveguide or the second coupling waveguide; and
a second transmitter arm comprising a second signal generator configured to generate optical signals of the second wavelength, the second transmitter arm in optical communication with at least one of the first coupling waveguide or the second coupling waveguide,
wherein:
the photonic circuit is configured for selective use in a bi-directional link or a co-directional link,
the first wavelength is different from the second wavelength,
optical filters of the first pair of receiver filters and the second pair of receiver filters are respective bandpass filters,
when at least one receiver filter of the first pair of receiver filters is tuned to pass the first wavelength, the photonic circuit is configured to receive optical signals of the first wavelength,
when the first pair of receiver filters is tuned to not pass the first wavelength, the photonic circuit is configured to transmit optical signals of the first wavelength,
when at least one receiver filter of the second pair of receiver filters is tuned to pass the second wavelength, the photonic circuit is configured to receive optical signals of the second wavelength, and
when the second pair of receiver filters is tuned to not pass the second wavelength, the photonic circuit is configured to transmit optical signals of the second wavelength.

19. The photonic circuit of claim 18, wherein whether the photonic circuit is configured to receive or transmit optical signals of the first wavelength and whether the photonic circuit is configured to receive or transmit optical signals of the second wavelength is controlled independently via tuning of the first pair of receiver filters and tuning of the second pair of receiver filters.

20. The photonic circuit of claim 18, wherein:
when the first pair of receiver filters are tuned to pass the first wavelength and the second pair of receiver filters are tuned to pass the second wavelength, the photonic circuit is configured to act as a co-directional receiving link,
when the first pair of receiver filters are tuned to not pass the first wavelength and the second pair of receiver filters are tuned to not pass the second wavelength, the photonic circuit is configured to act as a co-directional transmitting link, and
when the first pair of receiver filters is tuned to pass the first wavelength and the second pair of receiver filters is tuned to not pass the second wavelength, the photonic circuit is configured to act as a bi-directional link.

21. A method comprising:
at least one of receiving or transmitting respective signals of two or more wavelengths via a photonic circuit, wherein the photonic circuit comprises:
two or more wavelength branches, each wavelength branch of the two or more wavelength branches corresponding to a respective wavelength of the two or more wavelengths, each wavelength branch of the two or more wavelength branches comprising:
a receiver arm comprising a signal detection component configured to receive a respective signal of the respective wavelength; and
a transmitter arm comprising a signal generator configured to provide a respective signal of the respective wavelength.

22. The method of claim 21, wherein the photonic circuit further comprises a coupling waveguide and two or more receiver filters, wherein each receiver filter is a tunable filter and each receiver arm of the two or more wavelength branches is in optical communication with the coupling waveguide via a respective receiver filter of the two or more receiver filters, and the method further comprises:
prior to the at least one of receiving or transmitting the respective signals of the two or more wavelengths via the photonic circuit, tuning each receiver filter of the two or more receiver filters, wherein when the receiver filter is tuned to pass the respective wavelength, the wavelength branch corresponding to the respective wavelength is configured to act as a receiver, and wherein when the receiver filter is tuned to not pass the respective wavelength, the wavelength branch corresponding to the respective wavelength is configured to not act as a receiver.

23. An optical network comprising:
two or more photonic chips each configured to be operated as a selected one of a bi-directional link chip or a co-directional link chip,
wherein the optical network is configured to be operated in a selected one of a bi-directional mode or a co-directional mode based at least in part on whether the one or more photonic chips are operated as bi-directional link chips or co-directional link chips.

24. The optical network of claim 23, wherein each of the one or more photonic chips comprises:
at least one coupling waveguide;
two or more receiver filters, the two or more receiver filters each being a tunable bandpass filter; and
two or more wavelength branches, each wavelength branch of the two or more wavelength branches corresponding to a respective wavelength, each wavelength branch of the two or more wavelength branches comprising:
a receiver arm comprising a signal detection component, the receiver arm in optical communication with the at least one coupling waveguide via a receiver filter of the two or more receiver filters; and
a transmitter arm comprising a signal generator configured to provide a transmission signal to the at least one coupling waveguide,
wherein when the receiver filter is tuned to pass the respective wavelength, the wavelength branch corresponding to the respective wavelength is configured to act as a receiver, and
wherein when the receiver filter is tuned to not pass the respective wavelength, the wavelength branch corresponding to the respective wavelength is configured to not act as a receiver.
